(19) United States
(12) Patent Application Publication
(10) Pub. No.: US 2010/0250967 A1
(43) Pub. Date: Sep. 30, 2010

(54) Semiconductor integrated circuit and control, method of the same

(75) Inventor: Shunjiro Miwa, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/659,400

(22) Filed: Mar. 8, 2010

(30) Foreign Application Priority Data
Mar. 25, 2009 (JP) 2009-073532
Feb. 19, 2010 (JP) 2010-035218

(51) Int. Cl. H04L 9/00

(52) U.S. Cl. 713/190

(57) ABSTRACT

There is provided a semiconductor integrated circuit including a scan path circuit, which includes an encryption data storage unit that stores a secret key B created by encrypting a chip ID with use of a secret key A, and an encryption circuit that encrypts output data of the scan path circuit based on the secret key B and outputs the encrypted output data. This circuit configuration enables an increase in confidentiality in encryption of a scan test result.

### INCORPORATION BY REFERENCE

This application is based upon and claims the benefit of priority from Japanese patent application Nos. 2009-073532 and 2010-035218, filed on Mar. 25, 2009 and Feb. 19, 2010, the disclosure of which is incorporated herein in its entirety by reference.

### BACKGROUND

1. Field of the Invention

The present invention relates to a semiconductor integrated circuit and a control method of the same and, particularly, to encryption of a scan test result.

2. Description of Related Art

A scan path circuit is composed of an n-number (n is a natural number) of stages of scan flip flops (FFs). A circuit shown in FIG. 3 is an example in which four stages of scan FFs 500 to 503 are mounted.

The scan FFs 500 to 503 are supplied with a clock signal CLK and a scan enable signal SE. Further, an output signal Din0 from a logic circuit group (not shown) is input to a data input terminal of the scan FF 500. A scan test signal Sin from the outside, for example, is input to a scan data input terminal of the scan FF 500. An output signal Dout0 of the scan FF 500 is input to a scan data input terminal of the scan FF 501 and an input terminal of the logic circuit group. An output signal Din1 from the logic circuit group is input to a data input terminal of the scan FF 501. An output signal Dout1 of the scan FF 501 is input to a scan data input terminal of the scan FF 502 and the input terminal of the logic circuit group.

An output signal Din2 from the logic circuit group is input to a data input terminal of the scan FF 502. An output signal Dout2 of the scan FF 502 is input to a scan data input terminal of the scan FF 503 and the input terminal of the logic circuit group. An output signal Din3 from the logic circuit group is input to a data input terminal of the scan FF 503. An output signal Dout3 of the scan FF 503 is input to the input terminal of the logic circuit group and also output as a scan test signal Sout1 to the outside.

As described above, the scan FFs 500 to 503 of the circuit shown in FIG. 3 have the data input terminal to which data to be used in a normal operation is supplied and the scan data input terminal to which data to be used in a scan test is supplied. The scan FFs 500 to 503 select either one based on the signal SE and output the selected data in synchronization with the clock signal CLK.

Specifically, in the case where a semiconductor integrated circuit performs a normal operation, the signal SE is set to “0”, for example. At this time, the scan FFs 500 to 503 select data (Din 0 to 3) to be used in the normal operation. Then, the scan FFs 500 to 503 output the selected data (Din 0 to 3) as output data (Dout 0 to 3) in synchronization with the clock signal CLK. In this manner, in the case of a normal operation (and a capture operation at the time of a scan test), the scan FFs 500 to 503 constitute a sequential circuit that performs passing of data with the logic circuit group.

On the other hand, in the case where the semiconductor integrated circuit conducts a scan test, the signal SE is set to “1”. At this time, the scan FFs 500 to 503 select data to be used in the scan test. Then, the scan FFs 500 to 503 output the selected data to the scan data input terminal of the scan FF in the next stage (or to an external output terminal as for the scan FF 503) in synchronization with the clock signal CLK. In this manner, in the case of conducting a scan test, the scan FFs 500 to 503 constitute a shift register. In such a circuit configuration, it is possible to perform writing of a value to be set to each scan FF for a scan test and reading of a value of each scan FF after the scan test directly from the outside of the semiconductor integrated circuit.

As described above, the purpose of that the semiconductor integrated circuit constitutes a scan path circuit is to conduct a scan test, which is one of shipping test. The scan path circuit is capable of reading (outputting) the internal state of the semiconductor integrated circuit directly to the outside of the semiconductor integrated circuit. Thus, the scan path circuit principally has the following two issues in terms of security.

(1) It is possible to estimate the circuit configuration of the semiconductor integrated circuit based on the internal state of the semiconductor integrated circuit that is read from the scan path circuit. This enables reverse engineering that restores the circuit configuration of the semiconductor integrated circuit.

(2) It is possible to read a processing result in the case where the semiconductor integrated circuit operates normally to the outside of the semiconductor integrated circuit based on the internal state of the semiconductor integrated circuit that is read from the scan path circuit.

The issue (1) threatens the intellectual property rights for the circuit configuration which is held by a designer of the semiconductor integrated circuit. In other words, it threatens the secrecy concerning the circuit configuration. Further, the issue (2) threatens the secrecy concerning data that is handled by a user when using the semiconductor integrated circuit. In these two points, there is a high demand for the secrecy of the semiconductor integrated circuit.

FIG. 4 shows an overview of a design flow of a semiconductor integrated circuit. Referring to FIG. 4, a design process of a semiconductor integrated circuit first performs architecture design (S501). Next, the process performs circuit design (S502). The process then performs test design for conducting a failure test or the like of the semiconductor integrated circuit (S503). Then, the process performs layout design (S504). Design of a scan path circuit and a circuit of conducting a scan test is performed in the test design (S503). Therefore, even if a scheme for increasing the secrecy of the circuit is applied at the phase of the architecture design or the circuit design, there is a possibility that the confidentiality of the semiconductor integrated circuit is lost as a result of inserting a scan path at the time of the test design.

Further, in an application specific IC (ASIC), an ASIC user or an ASIC designer usually performs the architecture design (S501) and the circuit design (S502) of the semiconductor integrated circuit. After that, a semiconductor vendor performs the test design such as insertion of a scan path circuit (S503). Therefore, there is also a high demand for increasing the confidentiality of the semiconductor integrated circuit for a semiconductor vendor.

A solution for such issues is introduced in Japanese Unexamined Patent Application Publication No. 2001-141791. FIG. 5 shows a semiconductor circuit that is introduced in Japanese Unexamined Patent Application Publication No. 2001-141791. The circuit shown in FIG. 5 is composed of a combinational logic circuit C11, scan path circuits F11 and F12, an encryption circuit B11, and a mode holding circuit M11.

According to Japanese Unexamined Patent Application Publication No. 2001-141791, in the circuit shown in FIG. 5, during a scan mode operation (during a scan test), predetermined mode key data is input, blending into input data to the scan path circuits F11 and F12. The mode key data is then captured into a mode key circuit (not shown) placed in the scan path circuits F11 and F12. The mode key circuit exists in a given position on a scan path, corresponding to a given bit.

The encryption circuit B11 encrypts an output signal Sout1 of the scan path circuit F11 and outputs the signal as an output signal Bout1. Further, the encryption circuit B11 encrypts an output signal Sout2 of the scan path circuit F12 and outputs the signal as an output signal Bout2.

During a system mode operation (normal operation), the mode key data that is output from the mode key circuit is input to the mode holding circuit M11. The mode holding circuit M11 generates a mode signal BE corresponding to the mode key data and outputs the mode signal BE to the encryption circuit B11. When the mode key data indicates a predetermined pattern, the mode signal BE is a predetermined set value. At this time, the encryption circuit B11 outputs the signal Sout1 and the signal Sout2 as the output signal Bout1 and the output signal Bout2, respectively, without encrypting them. On the other hand, when the mode signal BE is different from the predetermined set value, the encryption circuit B11 encrypts the signal Sout1 and the signal Sout2 and outputs them. In this manner, the circuit shown in FIG. 5 can conceal (encrypt) the output of the scan path circuit according to need. As a result, if information of the mode key circuit and the mode key data is unknown, it is impossible to estimate the configuration of the internal circuit based on the encrypted output data of the scan path circuit.

As described above, in the case of the circuit shown in FIG. 5, those who do not know the configuration of the mode key circuit and the mode key are unable to read the internal state of the semiconductor integrated circuit based on the output data of the scan path circuit. It is thereby impossible to estimate the circuit configuration of the semiconductor integrated circuit. Thus, the above-described issues (1) and (2) can be avoided.

### SUMMARY

The present inventors, however, have found that if a circuit diagram (net list) of the semiconductor integrated circuit becomes known to the outside, there is a possibility that the configuration of the mode key circuit and the mode key will be read based on the circuit diagram. Thus, the issue (1) becomes unavoidable if the circuit diagram becomes known. Further, this makes the issue (2) unavoidable. Therefore, according to related art, there is a problem that not only the issue (1) but also the issue (2) is unavoidable if the circuit diagram of the semiconductor integrated circuit becomes known to the outside. Hence, according to related art, there is a problem that confidentiality is low in encryption of a scan test result or the like.

A first exemplary aspect of the present invention is a semiconductor integrated circuit including a scan path circuit (e.g. scan path circuits 101 and 102 in the first exemplary embodiment of the present invention), which includes an encryption data storage unit (e.g. an encryption data storage unit 105 in the first exemplary embodiment of the present invention) that stores a second encryption key (e.g. a secret key B in the first exemplary embodiment of the present invention) created by encrypting identification information (e.g. a chip ID in the first exemplary embodiment of the present invention) with use of a first encryption key (e.g. a secret key A in the first exemplary embodiment of the present invention), and an encryption circuit (e.g. an encryption circuit 104 in the first exemplary embodiment of the present invention) that encrypts output data of the scan path circuit based on the second encryption key and outputs the encrypted output data.

A second exemplary aspect of the present invention is a control method of a semiconductor integrated circuit including a scan path circuit, which includes storing a second encryption key created by encrypting identification information with use of a first encryption key, and encrypting output data of the scan path circuit based on the second encryption key and outputting the encrypted output data.

By the above-described configuration and control method, it is possible to increase the confidentiality in encryption of a scan test result.

According to the exemplary aspects of the present invention, it is possible to provide a semiconductor integrated circuit that enables an increase in confidentiality in encryption of a scan test result.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing a semiconductor integrated circuit according to a first exemplary embodiment of the present invention;

FIG. 2 is a view showing an encryption method of encryption data that encrypts an output result of a scan path circuit according to a first exemplary embodiment of the present invention;

FIG. 3 is a view showing an example of a scan path circuit;

FIG. 4 is a flowchart showing a flow of design of a semiconductor integrated circuit; and

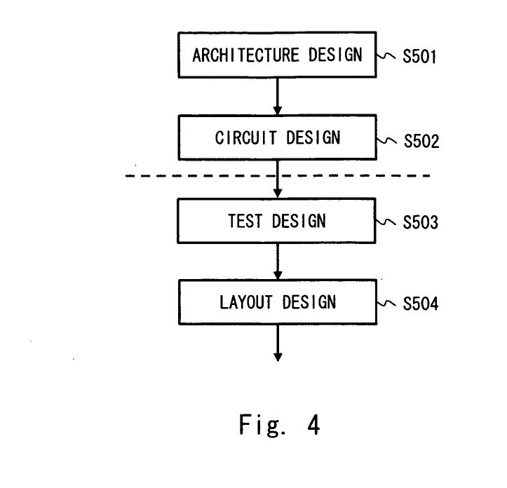

FIG. 5 is a view showing a semiconductor integrated circuit according to related art.

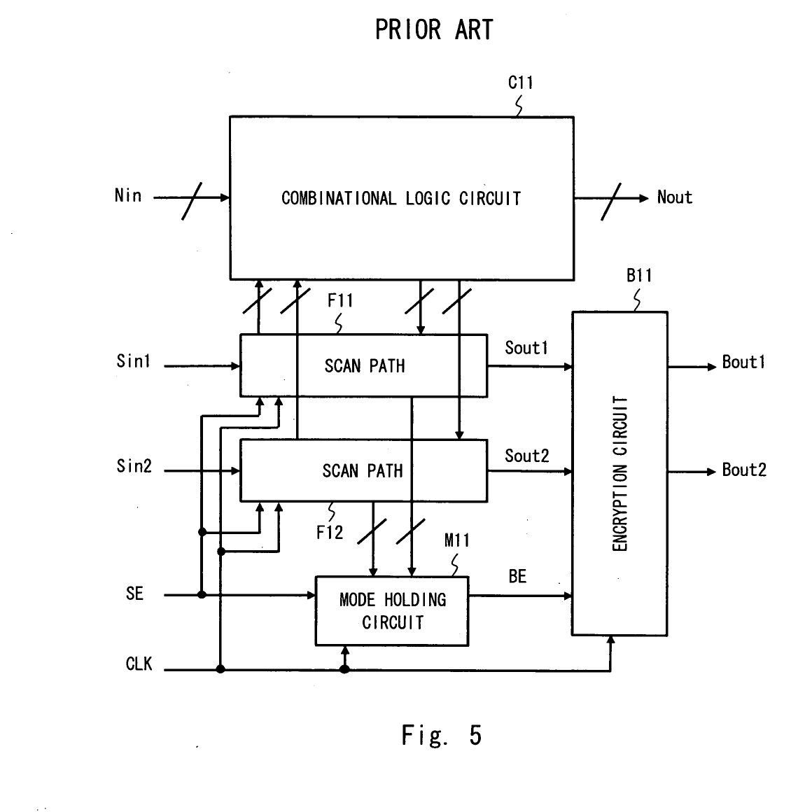

### DETAILED DESCRIPTION OF THE EXEMPLARY EMBODIMENTS

An exemplary embodiment of the present invention is described hereinafter in detail with reference to the drawings. In the drawings, the identical reference symbols denote identical structural elements, and redundant explanation thereof is omitted as appropriate to clarify the explanation.

### First Exemplary Embodiment

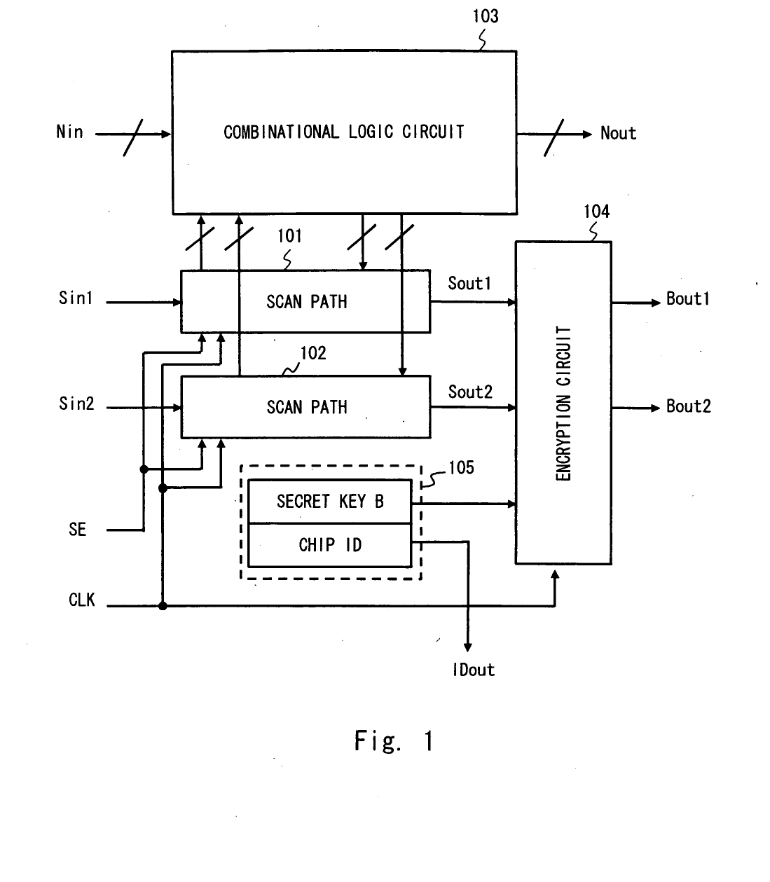

A first exemplary embodiment of the present invention is described hereinafter with reference to the drawings. FIG. 1 is a block diagram showing a semiconductor integrated circuit according to a first exemplary embodiment of the present invention. It should be noted that a semiconductor integrated circuit according to an exemplary embodiment of the present invention includes an encryption data storage unit that stores a secret key B (second encryption key) created by encrypting a unique ID (chip ID; identification information) uniquely assigned to each semiconductor integrated circuit with use of a secret key A (first encryption key) provided from the outside, and an encryption circuit that encrypts output data from a data scan path circuit based on the stored secret key B and outputs the data. In this configuration, even if a circuit diagram of the semiconductor integrated circuit becomes known, it is impossible to read a processing result when the semiconductor integrated circuit operates normally to the outside of the semiconductor integrated circuit by analyzing a scan test result.

The circuit shown in FIG. 1 includes scan path circuits 101 and 102 that output a scan test result, a combinational logic circuit 103 that is composed of a plurality of logic circuits different from a register, an encryption circuit 104 that encrypts a scan test result based on the secret key B and outputs the result, and an encryption data storage unit 105 that stores the secret key B. For simplification, the circuit shown in FIG. 1 includes two scan path circuits 101 and 102 by way of illustration.

The combinational logic circuit 103 performs predetermined digital signal processing and logical operation on one or more bits of input data Nin. The combinational logic circuit 103 then outputs a processing result as one or more bits of output data Nout. Further, the combinational logic circuit 103 receives output data from the scan path circuits 101 and 102 and performs predetermined processing on the input data. The combinational logic circuit 103 then transfers processing results to the scan path circuits 101 and 102, respectively.

The scan path circuits 101 and 102 are supplied with a scan enable signal SE and a clock signal CLK. Further, input data Sin1 is input to the scan path circuit 101. The scan path circuit 101 outputs output data Sout1 to the encryption circuit 104. Furthermore, input data Sin2 is input to the scan path circuit 102. The scan path circuit 102 outputs output data Sout2 to the encryption circuit 104.

The encryption circuit 104 encrypts the received data Sout1 and Sout2 and outputs them as output data Bout1 and Bout2, respectively. Further, the encryption circuit 104 is supplied with the clock signal CLK.

The scan path circuit 101 is composed of a plurality of scan flip-flops (which are simply referred to hereinafter as scan FFs) that are directly connected with one another, for example. First, the scan path circuit 101 sequentially shifts the input data Sin1 to the output side as a shift operation. Specifically, the scan path circuit 101 creates a test pattern by storing data corresponding to the input data Sin1 into each scan FF. Next, the scan path circuit 101 transmits the test pattern to the combinational logic circuit 103 as a capture operation. The scan path circuit 101 then receives a processing result from the combinational logic circuit 103. After that, the scan path circuit 101 sequentially shifts the processing result from the combinational logic circuit 103 stored in each scan FF to the output side again as a shift operation. Then, the scan path circuit 101 outputs the output data Sout1 to the encryption circuit 104. The operation of the scan path circuit 102 is the same as that of the scan path circuit 101.

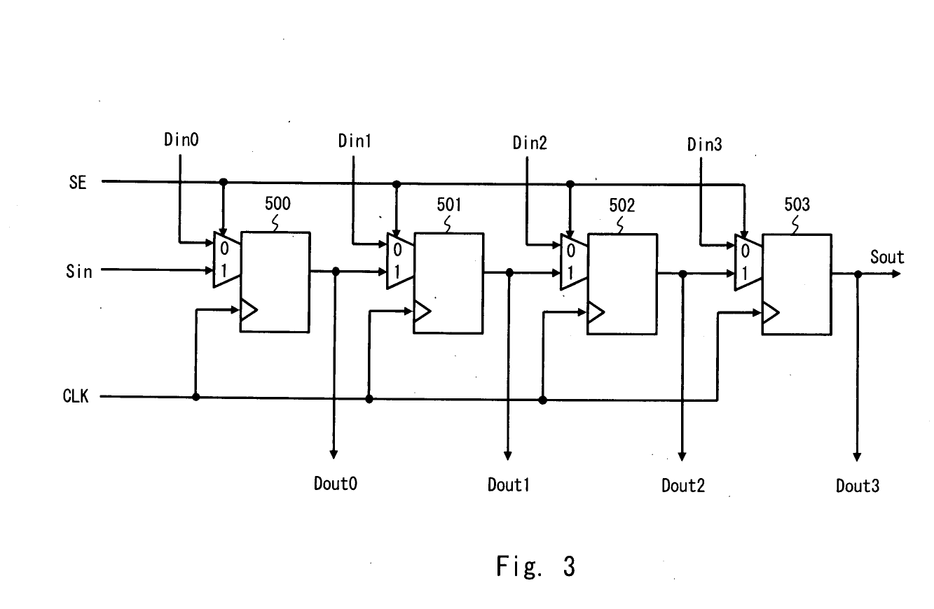

FIG. 3 shows an exemplary configuration of the scan path circuit 101. The scan path circuit 102 has substantially the same configuration as the scan path circuit 101 and thus not redundantly described. Further, the scan path circuit is composed of an n-number (n is a natural number) of stages of scan FFs, and, for simplification, the circuit shown in FIG. 3 includes four stages of scan FFs 500 to 503 by way of illustration.

The scan FFs 500 to 503 are supplied with the clock signal CLK and the signal SE. An output signal Din0 from the combinational logic circuit 103, for example, is input to a data input terminal of the scan FF 500. A scan test signal (input data) Sin from the outside, for example, is input to a scan data input terminal of the scan FF 500. An output signal Dout0 of the scan FF 500 is input to a scan data input terminal of the scan FF 501 and also transmitted to the combinational logic circuit 103. An output signal Din1 from the combinational logic circuit 103 is input to a data input terminal of the scan FF 501. An output signal Dout1 of the scan FF 501 is input to a scan data input terminal of the scan FF 502 and also transmitted to the combinational logic circuit 103.

An output signal Din2 from the combinational logic circuit 103 is input to a data input terminal of the scan FF 502. An output signal Dout2 of the scan FF 502 is input to a scan data input terminal of the scan FF 503 and also transmitted to the combinational logic circuit 103. An output signal Din3 from the combinational logic circuit 103 is input to a data input terminal of the scan FF 503. An output signal Dout3 of the scan FF 503 is input to an input terminal of the combinational logic circuit 103 and also output as a scan test signal (output data) Sout1 to the outside.

In this manner, the scan FFs 500 to 503 of the circuit shown in FIG. 3 have the data input terminal to which data to be used in a normal operation is supplied and the scan data input terminal to which data to be used in a scan test is supplied. The scan FFs 500 to 503 select either one based on the signal SE and output the selected data in synchronization with the clock signal CLK.

Specifically, in the case where a semiconductor integrated circuit performs a normal operation, the signal SE is set to “0”, for example. At this time, the scan FFs 500 to 503 select data (Din 0 to 3) to be used in the normal operation. Then, the scan FFs 500 to 503 output the selected data (Din 0 to 3) as output data (Dout 0 to 3) in synchronization with the clock signal CLK. In this manner, in the case of a normal operation (and a capture operation at the time of a scan test), the scan FFs 500 to 503 constitute a sequential circuit that performs passing of data with the logic circuit group.

On the other hand, in the case where the semiconductor integrated circuit conducts a scan test, the signal SE is set to “1”. At this time, the scan FFs 500 to 503 select data to be used in the scan test. Then, the scan FFs 500 to 503 output the selected data to the scan data input terminal of the scan FF in the next stage (or to an external output terminal as for the scan FF 503) in synchronization with the clock signal CLK. In this manner, in the case of conducting a scan test, the scan FFs 500 to 503 constitute a shift register. In such a circuit configuration, it is possible to perform writing of a value to be set to each scan FF for a scan test and reading of a value of each scan FF after the scan test directly from the outside of the semiconductor integrated circuit.

In FIG. 1, the encryption data storage unit 105 stores the secret key B to be output to the encryption circuit 104 and information of a unique ID (chip ID) that is uniquely assigned to each semiconductor integrated circuit. The secret key B is encryption key information that is created by encrypting the chip ID with use of the secret key A in the outside, for example. Thus, the secret key B differs by each semiconductor integrated circuit in this exemplary embodiment.

The chip ID and the secret key B are stored in a storage cell such as eFuse, for example. It is thereby possible to store an arbitrary data pattern. Further, a diffusion lot number and coordinates on a wafer are stored as information of the chip ID at the time of a shipping test (wafer test), for example.

The encryption data storage unit 105 outputs the secret key B to the encryption circuit 104 and also outputs the information of the chip ID as an output signal IDout to the outside. The encryption circuit 104 performs encryption processing based on the secret key B created by encrypting the chip ID with use of the secret key A. Specifically, the secret key B serves as a key for the encryption circuit 104 to execute encryption processing. Thus, in order to decrypt the output data (Bout1, Bout2) that has been encrypted by the encryption circuit 104, at least the information of the secret key B is required. Although the encryption data storage unit 105 stores the information of the chip ID and the secret key B based thereon in the circuit shown in FIG. 1 by way of illustration, it is not limited thereto. For example, a predetermined data pattern provided to each semiconductor integrated circuit may be used instead of the chip ID. Specifically, the data pattern may be encrypted with use of the secret key A in the outside and used as the secret key B.

In the related art, there has been a concern that if a circuit diagram of a semiconductor integrated circuit becomes known, a processing result when the semiconductor integrated circuit operates normally is read to the outside of the semiconductor integrated circuit by analyzing a scan test result. In view of this, in the semiconductor integrated circuit according to the exemplary embodiment of the present invention, the secret key B created by encrypting the chip ID with use of the secret key A in the outside is stored in the encryption data storage unit 105, thereby overcoming the concern in the related art.

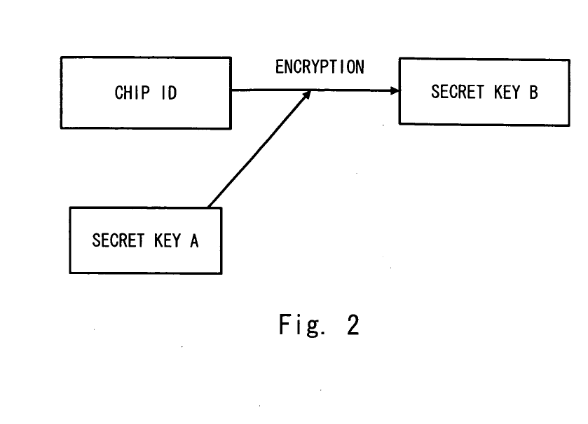

FIG. 2 is a view showing a method of encrypting the chip ID and creating the secret key B. Referring to FIG. 2, the chip ID is encrypted with use of the secret key A in the outside. The secret key B is written to the encryption data storage unit 105 at the time of a shipping test or the like, for example. The circuit shown in FIG. 1 outputs the information of the chip ID to the outside but does not output the secret key B to the outside.

It is necessary that the secret key A is shared as an important secret item among interested parties and kept not to be leaked to anyone except the interested parties. Further, a general encryption algorithm is used in the encryption circuit 104 that encrypts an output result of the scan path circuit.

As a specific example, at the time of a shipping test, a diffusion lot number, coordinates on a wafer or the like are written as a chip ID to the encryption data storage unit 105. Further, the secret key B is also written to the encryption data storage unit 105. Consequently, a unique secret key B is written to each semiconductor integrated circuit. The encryption circuit 104 encrypts an output result of the scan path circuit based on the secret key B created by encrypting the chip ID with use of the secret key A. It is thereby necessary to decrypt the output result of the scan path circuit when executing a scan test after shipping a product. When decrypting the output result of the scan path circuit, information of the chip ID that is written to the semiconductor integrated circuit is read to the outside first. Then, information of the secret key B is acquired based on the read information of the chip ID and the secret key A that is managed in the outside. Because a scan test result is encrypted by the secret key B, the encrypted scan test result can be decrypted by using the secret key B. Thus, the information of the chip ID and the secret key A are used also when decrypting the encrypted scan test result.

In such a circuit configuration, even if a circuit diagram of the semiconductor integrated circuit becomes known, because information of the secret key A is not contained in the circuit diagram, there is no possibility that information of the secret key B will become known. There is also no possibility that the encrypted scan test result will be decrypted.

As described above, in the semiconductor integrated circuit according to the exemplary embodiment of the present invention, the problem of the related art is solved by the following two points.

(1) A result of encrypting the information of the chip ID or the like with use of the secret key A that is kept in the outside is written as the secret key B for encrypting a scan test result to the encryption data storage unit 105. Thus, information of the secret key A does not exist in the circuit diagram.

(2) The secret key B is determined based on a diffusion lot number, coordinates information (chip ID) on a wafer or the like. Thus, a unique secret key B is given to each semiconductor integrated circuit.

Therefore, even if a circuit diagram becomes known to the outside, it is impossible to specify the secret key A from the circuit diagram for the above reason (1). It is thereby possible to prevent decryption of an encrypted scan test result.

Further, even if information of the secret key B that is written to a semiconductor integrated circuit is acquired by using focused ion beam (FIB) technique or the like, for example, it is impossible to decrypt an encrypted scan test result of another semiconductor integrated circuit with use of the secret key B acquired from a certain semiconductor integrated circuit for the above reason (2).

As described above, in the semiconductor integrated circuit according to the exemplary embodiment of the present invention, because of the two points of

(1) The secret key A cannot be specified from a circuit diagram, and

(2) A unique secret key B is given to each semiconductor integrated circuit, even if a circuit diagram of the semiconductor integrated circuit becomes known, confidentiality is maintained that “a processing result when the semiconductor integrated circuit operates normally cannot be read to the outside of the semiconductor integrated circuit”. It is thereby possible to prevent a processing result when the semiconductor integrated circuit operates normally from being read to the outside of the semiconductor integrated circuit by analyzing a scan test result.

The present invention is not limited to the above-described exemplary embodiment and may be appropriately changed without departing from the scope of the invention. For example, although the secret key B is determined based on a unique chip ID of each semiconductor integrated circuit in the semiconductor integrated circuit according to the exemplary embodiment of the present invention by way of illustration, the present invention is not limited thereto. For example, the secret key B may be an arbitrary key, not being unique to each semiconductor integrated circuit. In such a case also, the confidentiality can be maintained because the secret key B is encrypted by using the secret key A from the outside.

Further, although the encryption data storage unit 105 outputs information of a chip ID (or a signal corresponding thereto) to the outside in the semiconductor integrated circuit according to the exemplary embodiment of the present invention by way of illustration, the present invention is not limited thereto. For example, in the case where information of a chip ID is managed separately by a user or the like, it may be appropriately modified to the circuit configuration that does not output information of a chip ID to the outside.

Furthermore, although two scan path circuits are included in the semiconductor integrated circuit according to the exemplary embodiment of the present invention by way of illustration, the present invention is not limited thereto. The circuit configuration may be appropriately altered as long as it includes one or more scan path circuits.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A semiconductor integrated circuit including a scan path circuit, comprising:
an encryption data storage unit that stores a second encryption key created by encrypting identification information with use of a first encryption key; and
an encryption circuit that encrypts output data of the scan path circuit based on the second encryption key and outputs the encrypted output data.

2. The semiconductor integrated circuit according to claim 1, wherein the second encryption key is determined based on a unique ID assigned to the semiconductor integrated circuit.

3. The semiconductor integrated circuit according to claim 2, wherein the encrypted output data is decryptable based on the first encryption key and the ID.

4. The semiconductor integrated circuit according to claim 2, wherein the encryption data storage unit further stores information of the ID and outputs the information to outside.

5. The semiconductor integrated circuit according to claim 1, wherein the encrypted output data is output at time of a scan test.

6. A control method of a semiconductor integrated circuit including a scan path circuit, comprising:
storing a second encryption key created by encrypting identification information with use of a first encryption key; and
encrypting output data of the scan path circuit based on the second encryption key and outputting the encrypted output data.

7. The control method of a semiconductor integrated circuit according to claim 6, wherein the second encryption key is determined based on a unique ID assigned to the semiconductor integrated circuit.

8. The control method of a semiconductor integrated circuit according to claim 7, wherein the encrypted output data is decryptable based on the first encryption key and the ID.

9. The control method of a semiconductor integrated circuit according to claim 6, wherein the encrypted output data is output at time of a scan test.
